(19) United States
(12) Patent Application Publication
(10) Pub. No.: US 2022/0288806 A1
(43) Pub. Date: Sep. 15, 2022

(54) EXCHANGEABLE MACHINING UNIT

(71) Applicant: HOMAG GmbH, Schopfloch (DE)

(72) Inventors: Rainer SCHLOTTER, Horb (DE); Martin CALMBACH, Horb-Dießen (DE); Martin GRINGEL, Straßberg (DE)

(21) Appl. No.: 17/635,357

(22) PCT Filed: Aug. 14, 2020
(86) PCT No.: PCT/EP2020/072863

§ 371 Date: Feb. 14, 2022

(30) Foreign Application Priority Data
Aug. 14, 2019 (DE) 10 2019 121 878.0

(51) Int. Cl. B27D 5/00; B27G 11/00

(52) U.S. Cl. CPC B27D 5/003; B27G 11/00

(57) ABSTRACT

An exchangeable machining unit (1) for a machining centre (2) for machining workpieces (5) that preferably consist at least in sections of wood, wood-based materials, plastic or the like is disclosed, wherein the exchangeable machining unit (1) comprises a generator (10) for generating energy, selected from the group consisting of electrical, hydraulic, pneumatic, thermal energy, and radiation and vibration energy, in particular mechanical rotation energy of a drive spindle, in particular of a milling spindle, and has a drive (12) that can be supplied with energy by means of the generator (10). The generator (10) comprises an in particular releasable torque interface (14) for transmitting a torque from the outside to the machining unit (1). The generator (10) is configured to be driven by means of the torque, wherein the drive (12) is driven using the energy from the generator (10). A machining centre having such an exchangeable machining unit is also disclosed.

### TECHNICAL FIELD

The present invention relates to an exchangeable machining unit for a machining centre for machining plate-shaped workpieces that preferably consist at least in sections of wood, wood-based materials, plastic or the like.

### PRIOR ART

Machining units which can be substituted into the drive spindle, preferably the main spindle, particularly preferably the milling spindle, of a machining centre are known from DE 100 39 413 A1 and DE 102 29 775 C1, for example. For a desired machining operation to be carried out, a corresponding machining unit can be manually or automatically substituted from a storage device into the spindle unit of the machining centre.

Machining centres for machining plate-shaped workpieces, in particular of wood or wood-based materials, often comprise a machining unit, for example a gluing unit for gluing an edge material to a narrow face of the workpiece. This allows cutting machining, for example of a narrow face or of an edge of the workpiece, to be combined with gluing the edge material, such that there is no need to re-clamp the workpiece in a separate edge gluing machine. Various techniques are used for the gluing unit; for example, glue is applied to a workpiece narrow face by means of rollers and then edge material is placed onto the workpiece narrow face and is subsequently pressed against the workpiece narrow face using pressure rollers, for example. A subsequent setting of the glue ensures the edge material is firmly in place. Other gluing units work with a laser to irradiate and soften a coating already provided on the edge material used, in order to achieve a bond between the edge material and the narrow face of the workpiece by subsequently pressing the edge material onto the workpiece. Machining centres having a gluing unit are known from DE 10 2005 018 885 B3 and EP 0 728 561 A1, for example.

What the aforementioned machining units have in common is that for the coating process, energy has to be introduced into the edge material or adhesive layer to soften or activate the coating material or adhesive layer on the coating material. The liquid adhesives or glues used for gluing edge material are also generally applied in a heated state and set after application. Thus, the machining units comprise an electrical interface or cable connection in order to supply the energy required for heating the coating material as electrical energy to the machining unit. A purely mechanical connection of a machining unit was therefore not previously sufficient for operating a machining unit in the machining centre. Simply switching to different machining units having connected sensors or the like is therefore not possible either. An electrical interface or cable connection must also be provided. As a result, using the aforementioned machining units flexibly in different machining centres is made more difficult due to the interface requirements. The flexible use of machining units is therefore insufficient in the case of the machining units of the prior art.

It is known from EP 2 397 287 A1 that a machining unit for a machining centre for machining workpieces can be provided which is simplified in terms of its interface requirements by way of an energy supply of the machining unit, in that a generator is provided in the machining unit.

However, it has been shown that such a machining unit has limitations with respect to usability.

### DESCRIPTION OF THE INVENTION

The object of the present invention is therefore to provide an exchangeable machining unit, in particular a machining unit for a machining centre for machining workpieces that preferably consist at least in sections of wood, wood-based materials, plastic or the like, which can be used particularly flexibly in a wide variety of machining centres and which can be used generally and in various machining centres via a central connection option.

According to the invention, this object is achieved by an exchangeable machining unit having the features of claim 1. Advantageous embodiments and improvements of the invention can be found in the subclaims.

In particular, the invention was based on the finding that the limitations with respect to usability are due to the fact that while the machining unit comprises a generator driving the drive, the control of this drive takes place on the unit side via the main spindle, which by nature does not allow adequate control or regulation of the drive. On the basis of this finding, an exchangeable machining unit according to the invention therefore provides for a control device in the machining unit.

In other words, the invention is therefore based, in particular, on the idea of providing an exchangeable machining unit which is as simple as possible to couple and which controls or regulates itself independently, and which has an adaptable energy supply in said exchangeable machining unit.

An exchangeable machining unit according to the invention for a machining centre for machining workpieces that preferably consist at least in sections of wood, wood-based materials, plastic or the like comprises a generator for generating energy, selected from the group of electrical energy, hydraulic energy, pneumatic energy, thermal energy, and radiation and vibration energy, in particular mechanical rotation energy of a drive spindle, in particular of a milling spindle, of the machining centre, and comprises a drive that can be supplied with energy by means of the generator. In this regard, the generator comprises an in particular releasable torque interface for transmitting a torque from the outside to the machining unit. The torque interface may, for example, be configured as an HSK tool holder on the exchangeable machining unit, in particular on the generator of the exchangeable machining unit. The generator is configured to be driven by means of the torque, and the drive is driven using the energy from the generator.

The term “generator” within the meaning of this application refers to an energy converter in general. With this, a different form of energy is obtained from mechanical energy, i.e., for example, the rotational movement of the main spindle. For example, electrical energy, hydraulic energy, pneumatic energy, thermal energy as well as radiation and vibration energy have already been cited in this context.

Moreover, the aforementioned drive is an energy-consuming drive. In particular, by consuming energy, machining on a workpiece can take place; the other types of machining mentioned above are also conceivable, however. This means that a cylinder, a heating element, an actuator (as will be described in more detail below), a milling cutter, in particular a milling head, and/or a scanner, for example, can also be driven by the generator. It is also conceivable that an electric motor is driven as a drive by the generator, wherein the electric motor may in turn be configured to drive high-performance milling heads. Such electric motors, which drive high-performance milling heads for example, can achieve up to 60,000 rpm.

Irrespective of this, the aforementioned main spindles of the machining centre into which the machining unit can be substituted require, for example, a speed of more than 18,000 rpm, preferably more than 20,000 rpm, particularly preferably more than 24,000 rpm and more preferably still more than 30,000 rpm in the operating state.

In this context, the term “energy” is to be interpreted within the meaning of “information”, which may be, purely by way of example, mechanical energy, electrical energy, hydraulic energy, pneumatic energy, thermal energy as well as radiation and vibration energy.

According to the invention, the generator is configured to be driven by means of the torque. The energy, or information, used to heat the coating material is therefore supplied to the machining unit as mechanical energy, for example. In this case, a torque is transmitted to the machining unit, which drives a generator. However, as is made clear by the “information” interpretation, the term “energy” is not restricted to the energy forms that have been mentioned. What is decisive is that the generator is activated. According to the invention, in one embodiment the machining unit has no cable connection to the machine.

The generator in turn generates electrical energy, which is used to supply a drive, for example for heating coating material, and/or for driving a milling head, and/or for operating electrical monitoring sensors, with energy. The drive therefore converts the electrical energy generated by the generator into thermal energy, for example, for heating the coating material and/or into rotation energy for the milling head, and/or adapts the current intensity and/or voltage generated by the generator for an electric motor using electrical conversion, for example.

In other words, the drive is provided for heating, in particular coating material, and/or for cooling, shaping, primary shaping, cutting machining and/or non-cutting machining.

The transmission of electrical energy to the machining unit may be omitted, since the machining unit itself generates the electrical energy, using the generator, from the mechanical energy transmitted to said machining unit. As a result, the connection of the exchangeable machining unit to a machining centre is particularly simple since only a mechanical connection is required and the electrical connection in the form of cables and plug-in connectors as well as a control-related connection of the machining unit may be omitted. As a result, the machining unit can be particularly easily integrated into existing machining centres and can independently perform a control of the machining and process monitoring processes to be carried out.

The torque interface for transmitting the torque from the outside to the machining unit is preferably configured to be releasable, in order to accommodate the desire for a flexible connection of the machining unit to a machining centre. Conventional interface systems, such as releasable shaft-hub connections, couplings and corresponding transmission elements, can be used as the releasable torque interface. HSK tool holders can also be used.

Thus, according to the invention, additional preparation of the machine in the form of realising an electrical interface is not required in order to change the machining unit. It is therefore possible to retrofit, with relatively little effort, any conventional machining centre for substituting the machining unit according to the invention. Due to the low interface costs for exchanging a machining unit according to the invention, the costs for extending an existing machining centre having a machining unit are low.

Here, the torque interface is configured to absorb the torque from a drive spindle (machining spindle), for example, preferably a main or milling spindle of a connected machining centre. As a result, the generator can be driven by the torque of the drive spindle of the machining centre. Thus, additional energy input into the machining unit is not necessary. Preferably, a torque splitter is provided, which transmits some of the torque of the drive spindle of the machining centre into the torque interface for driving the generator and leaves the remaining torque for the machining operation.

Preferably, the drive is configured as an actuator. This means that the actuator can therefore operate in the exchangeable machining unit and can facilitate, for example, machining, orientation and/or scanning of a workpiece. In this way, it can be ensured that various modular functions can be facilitated with such an interchangeable machining unit—without having to adapt interfaces in the machining centre itself and/or in the exchangeable machining unit.

According to a further aspect, the drive is configured to adjust a movement, in particular of a machining means, of the machining unit in at least one plane and/or at least one axis and/or along at least one axis.

Thus, a fully automatic, independent and safe adjustment of machining parameters, machining means, various angles of connected devices, such as a scanning element and the like, can be achieved by the drive.

The term “machining means” can therefore be understood to be, for example, a scanning element or tool which can be manipulated by the drive and can be re-aligned, for example. Various tasks, for example at different orientation angles or in different planes, can therefore be carried out using the same exchanged machining unit, without the need for external intervention.

In this regard a scanning element, a tool, a machining angle, the orientation of certain sensors, the drive of the tool, a vacuum generation and/or a blowing device for compressed air generation can be used, adjusted and/or adapted accordingly as various embodiments for at least one drive in the exchangeable machining unit.

According to a further aspect, the exchangeable machining unit further comprises a control device, which is configured to control and/or to regulate the drive.

This makes it possible for the machining unit to be operated independently and without information supplied from the machining centre and for regulation, control and above all also optimisation processes to be carried out independently and directly at the exchangeable machining unit.

According to a preferred embodiment of the present invention, the exchangeable machining unit has a heatable container for the coating material.

Using this container, heated coating material can be provided and stored. Particularly preferably, the drive for heating the coating material is integrated in the container. This results in a technically particularly simple design with few system interfaces.

According to a particularly preferred embodiment of the present invention, the drive for heating the coating material is configured to heat the coating material on workpieces already coated with coating material.

It is therefore possible to use coating material or workpieces having a thermally activatable glue or adhesive layer.

Preferably, the drive has an energy source, for example for heating coating material, for introducing lettering and/or for surface treatment. For transmitting the energy to a workpiece, various methods can therefore be used. For instance, energy can be transmitted to the coating material using a laser, a radiation source, an ultrasound source, a microwave source or a plasma source. Preferably, the “radiation source” can be understood here to be an infrared radiation source or an ultraviolet radiation source, wherein typically the wavelengths of the emitted beams of such a radiation source are in a range from 780 nm to 1 mm or 380 nm to 100 nm. The use of a hot air source or a gassing source is also possible. The key feature of these energy transmission techniques by the drive for heating the coating material is that the energy can be transmitted over a distance from the energy source to the coating material.

According to a preferred embodiment of the present invention, the exchangeable machining unit comprises a data transmission interface, preferably a wireless data transmission interface, for transmitting status data relating to the exchangeable machining unit to a machine controller.

For using the exchangeable machining unit it is advantageous to record certain status data relating to the exchangeable machining unit, for example in a machine controller. The temperature of the coating material or also the amount of coating material stored temporarily in the exchangeable machining unit, for example, is relevant for process control.

Preferably, the data transmission interface is also supplied with energy from the generator and the transmission of the data to a controller, for example the controller of the machining centre, takes places wirelessly. As a result, a plug-in connector for transmitting the data can then also be omitted for the data transmission of the exchangeable machining unit.

This allows the interface of the exchangeable machining unit to remain limited to the mechanical interface, which keeps the design of the exchangeable machining unit simple in terms of its interface requirements. Particularly preferably, a standard data transmission interface, such as radio Ethernet, Bluetooth, NFC or wireless LAN (Wireless Local Area Network), is provided in the exchangeable machining unit for the data transmission. Thus, the data transmission interface is configured to send and receive data wirelessly.

According to a further aspect, the data transmission interface is further configured to transmit data to a decentralised machine controller for a cloud-based control of the machining unit.

According to such an embodiment, it is possible, for example, for a plurality of machining units in one machining centre or even a plurality of machining centres having a plurality of machining units to be controlled, monitored and updated in a decentralised manner. Thus, it is possible to reduce the costs of control at the respective machining units and therefore to improve the efficiency and usability of such a device. Furthermore, the decentralised, cloud-based control of the machining unit makes it possible for persons skilled in the art at the manufacturer, for example, to access relevant data themselves in order to determine and, where necessary, to adjust operating parameters and optimisation potential.

According to a further preferred embodiment, an additional drive is connected to the generator. The additional drive can be driven by means of the generator. In this regard, it is preferred that the additional drive can be driven by the generator with a different torque from the drive. Thus, a plurality of drives can be arranged in one exchangeable machining unit.

According to a further aspect, the exchangeable machining unit further comprises at least one sensor device for safeguarding and/or checking at least one operating state of the exchangeable machining unit.

In this regard, the sensor can be understood to be, for example, a sensor for detecting and monitoring a vacuum of a vacuum pump mounted as a drive, for monitoring an amount of compressed air of a connected compressed air pump, for checking that an end position, for example of a workpiece, has been reached, for checking a coupling state of a tool that has been mounted on the drive or changed, for performing a distance measurement for example from a reference object, for example in the form of a tool or workpiece and/or a sensor for checking the correct execution or adjustment of the scanning of a workpiece. Checking and monitoring a temperature, for example of a heated coating material, can also be achieved with such a sensor device.

According to the invention, a machining centre having an exchangeable machining unit as according to one of the aforementioned aspects is also disclosed.

### BRIEF DESCRIPTION OF THE DRAWINGS

The invention will be explained in more detail in the following, on the basis of embodiment examples and with reference to the accompanying drawings.

In the drawings:

FIG. 1 shows a perspective view of an exchangeable machining unit according to the invention which is mounted on a machining centre, as according to a first embodiment; and

FIG. 2 shows a schematic drawing of the design of an exchangeable machining unit according to the invention, as according to a second embodiment.

In the drawings, the same reference numbers denote identical or functionally equivalent components, unless otherwise stated.

### DETAILED DESCRIPTION OF THE PREFERRED EMBODIMENTS

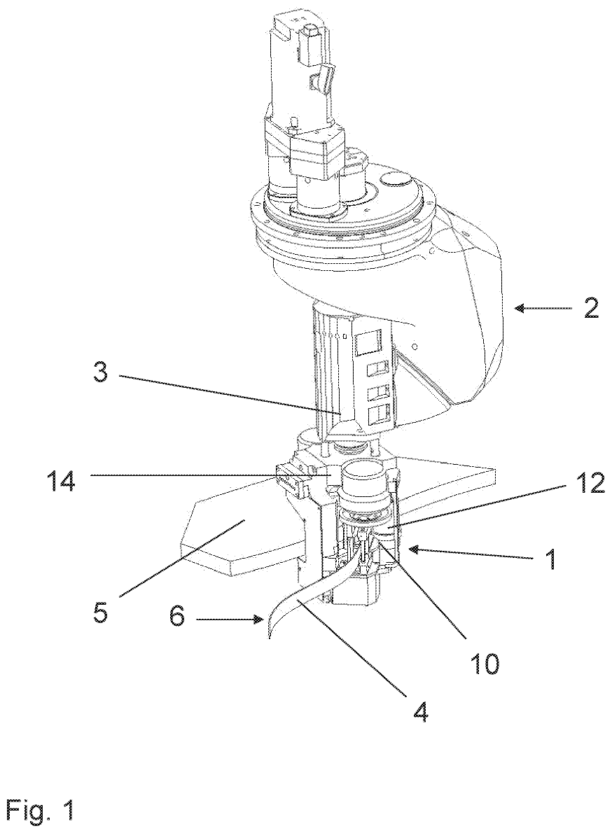

FIG. 1 shows a perspective view of an exchangeable machining unit 1 (machining unit) according to the invention which is mounted on a machining centre 2, as according to a first embodiment. The machining unit 1 is shown at the bottom of the drawing and is mounted on the machining centre 2 partially shown above. In this exemplary embodiment, the object of the machining unit 1 according to this embodiment example is to apply edges 4, which are coated with coating material 6, to the workpiece 5. The machining unit 1 is driven by a drive spindle 3 of the machining centre 2. The machining unit 1 further comprises a drive 12, in this case for heating the coating material 6. The drive 12 for heating the coating material 6 is connected to a generator 10, wherein the generator 10 can be driven via a torque interface 14 by means of the drive spindle 3 of the machining centre 2.

In operation, the coating material 6 is heated by means of a drive 12 for heating the coating material 6, thereby activating the adhesive effect thereof. Then, the edge 4 with the coating material 6 is pressed against the workpiece 5. After cooling, the bond of the edge 4 to the coating material 6 and the workpiece 5 cures. In this embodiment example, the machining centre 2 is a 5-axis machining centre. According to the invention, the machining unit 1 can be operated in machining centres 2 with different kinematics.

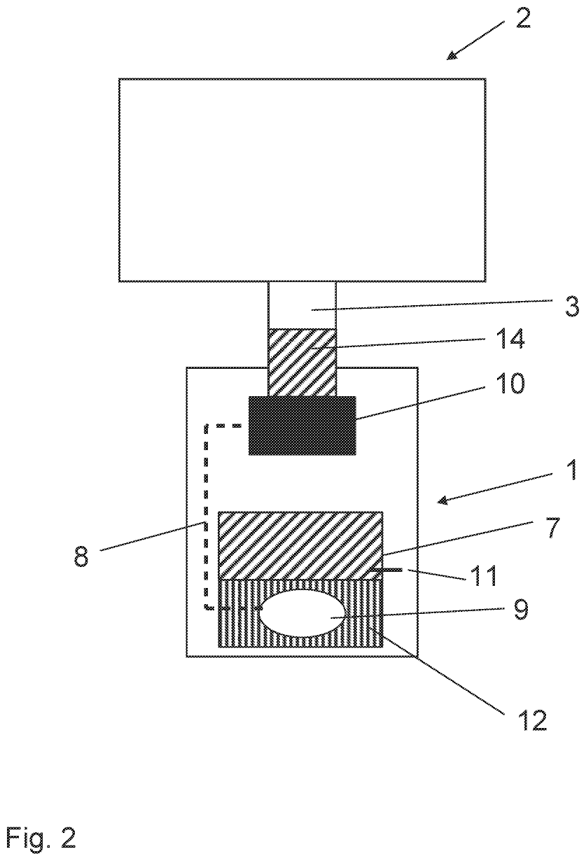

FIG. 2 shows a schematic drawing of the design of an exchangeable machining unit 1 according to the invention, as according to a second embodiment. As in FIG. 1, the machining centre 2 is shown at the top of the drawing and at the bottom an exchangeable machining unit 1 is shown. A drive spindle 3 is provided in the machining centre 2, which can be connected or, as shown in FIG. 2, which is connected to a torque interface 14 of the machining unit 1. The torque interface 14 of the machining unit 1 is connected to a generator 10 for generating electrical energy of the machining unit 1. An electrical line 8, which is shown as a dotted line, connects the generator 10 to a drive 12, for example for heating coating material 6, in order to supply electrical energy to the drive 12 for heating coating material 6. The coating material 6, which in this embodiment example is arranged in a container 7 on the drive 12 for heating coating material 6, can be heated by means of an energy source 9 on the drive 12 for heating coating material 6. Status data, such as the temperature of the coating material 6, are transmitted to the machining centre 2 by means of a data transmission interface (not shown).

Moreover, the machining unit 1 comprises a control device 11. The control device 11 is configured to control or to regulate the drive 12. Some or all of the energy supplied by the generator 10 can be used, as a result of which particularly accurate heating is facilitated in the exemplary embodiment shown here.

According to a further exemplary embodiment, which is not shown, the drive 12 may be provided as a milling device. The control device 11 described above can be used, for example, to realise a milling speed that is adapted to a workpiece to be machined. A gear transmission ratio to achieve desired speeds by means of an intermediate electric motor is also possible.

The control device 11 is provided for instance as a feedback-loop controller, which compares target states with actual states of a control variable by means of a sensor. This means that the control device can monitor various process parameters of such a machining device, for example by means of sensors, and can react to changes accordingly and independently and automatically optimise or adapt processes. In such an exemplary embodiment, compressed air sensors may be provided for removing cut chips, for example, or also for coupling tools or for reaching an end position of the tool.

Thus, a fully automatic and individually connectable design of an exchangeable machining unit is realised with a single mechanical interface, which unit is driven by means of the generator and also carries the sensors, which can also be driven by the generator. In other words, in such a further exemplary embodiment (not shown), the exchangeable machining unit can perform machining on a workpiece, including fully automatic alignment and monitoring by sensors, without certain connections having to be adapted when changing the tool or during operation.

The exchangeable machining unit 1 according to the invention makes it possible to equip a machining centre 2 with said machining unit without an electrical energy supply having to be realised between the machining centre 2 and the machining unit 1. The energy required for heating the coating material 6, for example, can be generated for this from the mechanical energy transmitted by the machining centre 2 to the machining unit 1 by means of a generator 10 of the machining unit 1. The machining unit 1 can therefore be used particularly flexibly in the machining centre 2. Furthermore, the machining unit 1 can be universally used also in machining centres 2 in which corresponding electrical interfaces for transmitting energy to the unit 1 are not provided.

Although the present invention has been described on the basis of preferred embodiment examples, it is not limited thereto; rather, it can be modified in a multitude of ways.

### List of Reference Numbers

1 Exchangeable machining unit
2 Machining centre
3 Drive spindle
4 Edge
5 Workpiece
6 Coating material
7 Container
8 Line
9 Energy source
10 Generator
11 Control device
12 Drive
14 Torque interface of the machining centre

1. Exchangeable machining unit for a machining centre for machining workpieces that consist at least in sections of wood, wood-based materials, plastic or the like, the exchangeable machining unit comprising:
a generator for generating energy selected from the group of electrical, hydraulic, pneumatic, thermal energy, and radiation and vibration energy of the machining centre, and
a drive that can be supplied with energy by means of the generator,
the generator comprising a releasable, torque interface for transmitting a torque from the outside to the machining unit, and
the generator being configured to be driven by means of the torque,
characterised in that
the drive is driven using the energy from the generator.

2. Exchangeable machining unit according to claim 1, wherein the drive is an actuator.

3. Exchangeable machining unit according to claim 1, wherein the drive is configured to adjust a movement of the machining unit in at least one plane and/or about at least one axis and/or along at least one axis.

4. Exchangeable machining unit according to claim 1, wherein the machining unit further comprises a control device, which is configured to control and/or to regulate the drive.

5. Exchangeable machining unit according to claim 1, wherein the drive is provided for heating, in particular coating material, and/or for cooling, shaping, primary shaping, cutting machining and/or non-cutting machining.

6. Exchangeable machining unit according to claim 1, wherein the torque interface is configured to absorb the torque of the drive spindle of the machining centre.

7. Exchangeable machining unit according to claim 1, wherein the exchangeable machining unit comprises a heatable container for the coating material.

8. Exchangeable machining unit according to claim 6, wherein an energy source is provided on the exchangeable machining unit, which is selected from the group consisting of: laser, hot-air source, radiation source, in particular an infrared and/or ultraviolet radiation source, ultrasound source, magnetic field source, microwave source, plasma source and gassing source.

9. Exchangeable machining unit according to claim 1, wherein the exchangeable machining unit comprises a data transmission interface for controlling the control device of the exchangeable machining unit, wherein the data transmission interface is configured to send and receive data by means of NFC and/or Bluetooth.

10. Exchangeable machining unit according to claim 9, wherein the data transmission interface is further configured to transmit data to a decentralised machine controller for a cloud-based control of the machining unit.

11. Exchangeable machining unit according to claim 1, wherein an additional drive is connected to the generator, wherein the additional drive can be driven by means of the generator with a different torque from the drive.

12. Exchangeable machining unit according to claim 1, wherein the exchangeable machining unit further comprises at least one sensor device for safeguarding and/or checking at least one operating state of the exchangeable machining unit.

13. Exchangeable machining unit according to claim 12, wherein the operating state is an adjustment made to the scanning and/or a check of a vacuum generated, and/or a detection of a successful connection of a substituted tool and/or a check of a predefined distance and/or a check of an end position of a reference object and/or a check of a temperature.

14. (canceled)
